(19) United States
(12) Patent Application Publication
(10) Pub. No.: US 2003/0187776 A1
(43) Pub. Date: Oct. 2, 2003

(54) Selecting method for accurately selecting an order receiver by an orderer

(75) Inventors: Yuko Kikuta, Hyogo (JP); Masayoshi Mori, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/241,491

(22) Filed: Sep. 12, 2002

(30) Foreign Application Priority Data
Mar. 28, 2002 (JP) 2002-091714

(51) Int. Cl. G06F 17/60

(52) U.S. Cl. 705/37

(57) ABSTRACT

A mask manufacturer selecting method includes the steps of entering factor data including two or more selectable factors by the mask manufacturer affecting a price to be paid by a wafer manufacturer for manufacturing of a photomask; and sending the factor data to computers of mask manufacturers. The mask manufacturer's computer sends estimate data including an estimated price determined based on the factors selected from the two or more factors. The mask manufacturer selecting method further includes the steps of receiving the estimate data; and selecting one order receiver based on the two or more estimate data received from the two or more mask manufacturers' computers.

### BACKGROUND OF THE INVENTION

1. Field of the Invention

The present invention relates to a method, in which an orderer or outsourcer can select one order receiver undertaking manufacturing of objects from two or more manufacturers, and particularly to a method employed in a semiconductor device ordering system for selecting an order receiver undertaking manufacturing of photomasks, which are used as original plates of wafers for the semiconductor devices.

2. Description of the Background Art

IC (Integrated Circuit) chips provided with circuits, of which wiring patterns are changed in accordance with specifications requested by clients, have been manufactured by IC chip manufactures (i.e., wafer manufacturers). Steps of manufacturing such IC chips include a photolithography step using a photomask, which has a light shield pattern made of a thin metal film and arranged on a synthetic quartz substrate, as a master or original plate. Information relating to specifications is sent from an orderer, i.e., a wafer manufacturer to a mask manufacturer, i.e., an order receiver via a magnetic tape or the like storing the information or online. The mask manufacturer prepares manufacturing data for manufacturing the photomask based on the received information relating to the specifications. Order information such as a quantity of the photomasks, delivery date and others are sent from the orderer, i.e., wafer manufacturer to the order receiver, i.e., mask manufacturer by telephone or online. Based the order information, the mask manufacturer produces management data including information required in production management such as a priority, a product code, a shipping destination and a delivery date as well as information required for quality management. The management data thus prepared is sent to a photomask manufacturing line. The photomask manufacturing line manufactures the photomask based on the manufacturing data prepared based on the specifications and the management data prepared based on the order information. The photomask is produced, e.g., by an electron beam exposing device controlled by the manufacturing data.

An example of such IC chip manufacturing system is disclosed in Japanese Patent Laying-Open No. 9-180980. In the system disclosed in this publication, IC chips are manufactured through a plurality of steps including an exposing step, in which an exposing pattern is changed in accordance with specifications requested by clients. This system includes input terminals, a processing unit and a manufacturing line. The input terminals are provided corresponding to respective clients. The input terminal includes an input circuit for entering information including specifications and a quantity of IC chips requested by the client. The processing unit includes a producing circuit for producing data required for the exposing step and data required for production and quality management of the IC chips, and a transfer circuit for transferring the data produced by the producing circuit to the manufacturing line. The manufacturing line manufactures the IC chips in accordance with the data transferred from the processing unit.

According to this system, the input terminal is provided for each client, and the information including the specifications and quantity of the semiconductor devices is entered only via this input terminal. Therefore, the information including the specifications and quantity of the semiconductor devices and others can be rapidly and easily processed as compared with a conventional system, in which such information is sent in various manners using magnetic tape, telephone or the like. Therefore, the priority of the order can also be managed more easily.

Another Japanese Patent Laying-Open No. 11-39389 has disclosed an electronic purchasing system for purchasing materials at an appropriate price and rapidly determining a supplier of the materials. This electronic purchasing system includes a host computer of an orderer of the materials and a client computer of an order receiver. The host computer includes an input circuit for entering estimate request data, which includes data representing contents of the estimate, by the orderer, a sending circuit for sending the estimate request data to the client computer over a communication network, a display circuit for receiving and displaying estimate response data sent from the client computer, and a control circuit for controlling the display circuit to display the estimate response data in the same screen display format as the estimate request data displayed by the display circuit. The client computer includes a receiving circuit for receiving the estimate request data from the host computer, a display circuit for displaying the received estimate request data, an input circuit for entering an estimated price corresponding to the estimate contents in the estimate request data, and a sending circuit for sending the estimate response data to the host computer over a network.

According to this electronic purchasing system, the orderer of materials can confirm, on the host computer, the estimate response data in the same screen display format as that for the estimate request. Therefore, it is possible to determine easily the relationship between the estimated prices and the contents of the estimate request.

Although the transfer circuit of the system disclosed in Japanese Patent Laying-Open No. 9-180980 transfers the data produced by the producing circuit in order of priority, the order of priority is not specifically disclosed in this reference. In the process of ordering the photomask, there are many factors determining such priority. The factors employed in each mask manufacturer are significantly different from those of the other manufacturers. Accordingly, one mask manufacturer cannot be selected from a plurality of mask manufacturers without difficulty, and such selection has been done based on human's determination or judgement. Even when the estimated price, which is one of factors for selecting the mask manufacturer, is received by the electronic purchasing system disclosed in Japanese Patent Laying-Open No. 11-39389, the following problem arises. In the electronic purchasing system, the potential order receiver enters the estimated price by using the client computer, which is determined based on the estimate request data sent from the host computer of the orderer. Therefore, the estimated price, which is one of the factors for determining the actual order receiver, must be determined by the potential order receiver so that the estimated price may reflect the estimate contents provided by the orderer. However, each mask manufacturer calculates the estimated price based on the factors different from those of the other mask manufacturers. For example, a certain mask manufacturer has photomask manufacturing technologies different from those employed by other mask manufacturers for manufacturing the substantially same photomasks. If the manufacturers of potential order receivers uniformly calculated the estimated prices in accordance with the data for requested estimate, differences between the manufacturing technologies would hardly appear. Conversely, if the orderer allowed the mask manufacturers to determine freely the data for requested estimate other than the specifications and quantity, the orderer could not make a simple comparison between the estimated prices provided by the plurality of mask manufacturers.

### SUMMARY OF THE INVENTION

An object of the invention is to provide a selecting method of selecting an order receiver, and particularly to provide a method allowing easy selection of an order receiver undertaking manufacturing of materials.

Another object of the invention is to provide a selecting method of selecting an order receiver, and particularly to provide a method allowing accurate selection of an order receiver undertaking manufacturing of materials.

Still another object of the invention is to provide a selecting method of selecting an order receiver, and particularly to provide a method allowing easy selection of an order receiver undertaking provision of service.

Yet another object of the invention is to provide a selecting method of selecting an order receiver, and particularly to provide a method allowing accurate selection of an order receiver undertaking provision of service.

Further another object of the invention is to provide a selecting method allowing easy and accurate selection of a mask manufacturer, which will undertake manufacturing of a photomask, by a wafer manufacturer.

A selecting method according to the invention selects one order receiver from two or more potential order receivers undertaking either manufacturing of an object or provision of service for an orderer. The method includes the steps of entering, by the orderer, price factor data including two or more factors affecting a price to be paid by the orderer for the manufacturing of the object or the provision of the service; and sending the price factor data to computers of the potential order receivers. The potential order receivers receiving the price factor data prepare and send estimate data including an estimated price for the manufacturing of the object or the provision of the service, based on the factors selected from the two or more factors. The selecting method further includes the steps of receiving the estimate data, storing the received estimate data; and selecting one order receiver from the potential order receivers based on the two or more estimate data received from the two or more potential order receivers.

The orderer enters the price factor data. This price factor data represents factors affecting the price to be paid by the orderer for the object manufacturing or the service provision. This price factor data is sent to the computer of the potential order receiver. The potential order receiver receiving this price factor data calculates an estimated price for the object manufacturing or the service provision based on factors selected by the potential order receiver itself from the two or more factors. The two or more estimate data including the estimated price thus calculated are received. Based on the estimate data such as the selected factors and the estimated prices received from the computers of the potential order receivers, the one order receiver is selected from the two or more potential order receivers. Thereby, the potential order receiver can calculate the estimated price by selecting the factors, which match with the conditions of the potential order receiver itself, from the factors entered by the orderer. Since the potential order receiver can calculate the estimated price by freely selecting the factors affecting the price from a range determined by the orderer, the potential order receiver can calculate the estimated price in accordance with the specifications requested by the order and under the conditions, in which the potential order receiver is strong. Consequently, it is possible to provide the order receiver selecting method, in which a manufacturer undertaking the manufacturing of photomasks or the like can be easily and accurately selected.

Preferably, the selecting method further includes the step of preparing order data for the one order receiver selected in the step of selecting the one order receiver.

Thereby, the order data to be sent to the selected one order receiver can be prepared.

More preferably, the selecting method further includes the step of sending the order data prepared in the step of preparing the order data to the computer of the order receiver.

The order data to be sent to the selected one order receiver can be sent to the computer of the order receiver so that an ordering procedure can be automatically executed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a whole structure of a mask manufacturer selecting system according to an embodiment of the invention;

FIG. 2 shows an outer appearance of a computer achieving a server shown in FIG. 1;

FIG. 3 is a control block diagram of the computer shown in FIG. 2;

FIG. 4 illustrates order specification data stored in the server;

FIG. 5 illustrates price factor data sent from the server to a computer of a mask manufacturer;

FIG. 6 illustrates condition data of price factors sent from the server to the computer of the mask manufacturer;

FIG. 7 illustrates a price table data sent from the computer of the mask manufacturer to the server;

FIG. 8 illustrates a unit price data sent from the computer of the mask manufacturer to the server;

FIG. 9 is a flowchart illustrating a control structure of a program executed in a mask manufacturer selecting system according to an embodiment of the invention; and

FIGS. 10-12 show examples of contents displayed on a screen of the computer of the mask manufacturer.

### DESCRIPTION OF THE PREFERRED EMBODIMENTS

Embodiments of the invention will now be described with reference to the drawings. In the following description and drawings, the same parts and portions bear the same reference numbers and the same names, and perform the same functions. Therefore, specific description thereof is not repeated.

The following description will now be given on a mask manufacturer selecting system for selecting a mask manufacturer undertaking the manufacturing of photomasks. However, the invention is not restricted to this. The invention can be applied to any one of systems for selecting manufacturers of objects other than the photomask and providers of service other than the object manufacturing.

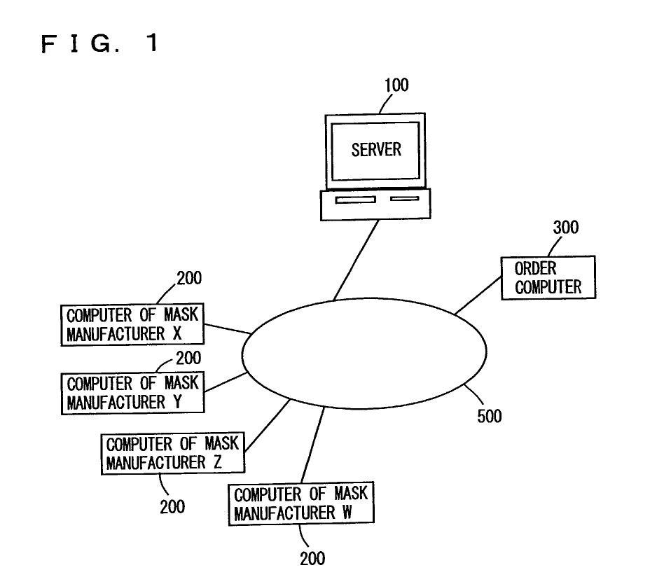

Referring to FIG. 1, a mask manufacturer selecting system according to an embodiment of the invention includes computers 200 of a plurality of mask manufacturers, which can manufacture photomasks, an order computer 300 for preparing order data for a photomask and sending it to computer 200 of the mask manufacturer selected by a server 100, and server 100 connected to these computers over a network 500.

Server 100 stores order specification data of factors for determining a price of the photomask. Server 100 is supplied with factors, which are selected from the order specification data thus stored and relate to the photomask to be estimated for ordering. Server 100 sends data (price table data) representing the selected factors and data representing conditions of the selected factors to computers 200 of the plurality of mask manufacturers. Each mask manufacture's computer 200 is supplied with the factors, which are selected by the mask manufacturer from the factors contained in the received price table data, and the conditions of the selected factors. Mask manufacturer's computer 200 is supplied with unit price data of the photomask corresponding to the selected factors and conditions. Mask manufacturer's computer 200 sends the selected factors and unit price data to server 100. Server 100 selects the mask manufacturer, with which an order for the photomasks is to be placed, based on the received data. In this manner, server 100 achieves a mask manufacturer selecting function for selecting the order receiver for the photomask from the plurality of mask manufacturers.

The mask manufacturer selecting function in server 100 of the mask manufacturer selecting system according to this embodiment is achieved by executing predetermined programs by CPUs (Central Processing Units) of the computers.

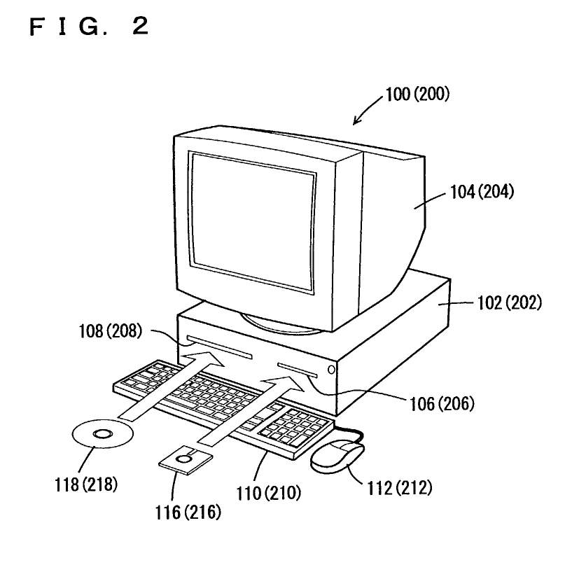

FIG. 2 shows an outer appearance of a computer system, which is an example of server 100 achieving the mask manufacturer selecting function. Referring to FIG. 2, the computer system includes a computer 102 provided with a FD (Flexible Disk) drive 106 and a CD-ROM (Compact Disk Read-Only Memory) drive 108, a monitor 104, a keyboard 110 and a mouse 112.

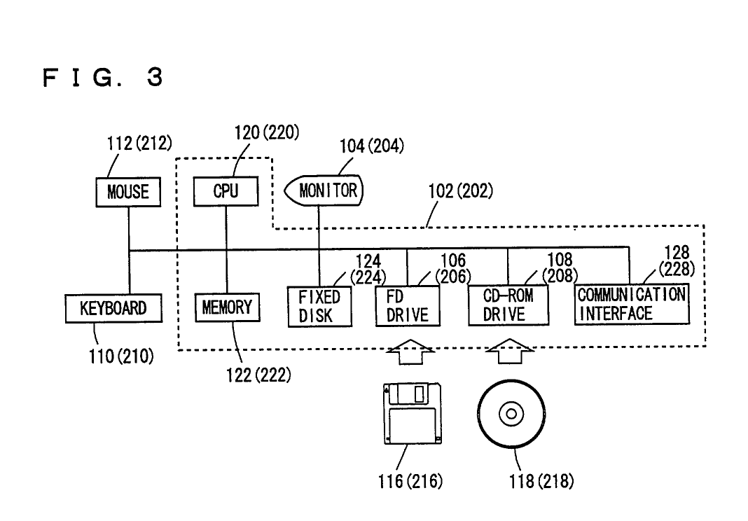

FIG. 3 is a block diagram showing a structure of this computer system. As shown in FIG. 3, computer 102 includes, in addition to FD drive 106 and CD-ROM drive 108, a CPU (Central Processing Unit) 120, a memory 122, a fixed disk 124 and a communication interface 128 for communication with other computers. These units and portions are mutually connected via a bus. A FD (Flexible Disk) 116 is loaded into FD drive 106. A CD-ROM 118 is loaded into CD-ROM drive 108. These flexible disk 116 and CD-ROM 118 bear predetermined programs corresponding to software.

As already described, server 100 having the mask manufacturer selecting function is achieved by the computer hardware and the software executed by CPU 120. In general, such software is stored and distributed in the form of programs stored in a record medium such as flexible disk 116 or CD-ROM 118. Further, the software is read from the record medium by FD drive 106, CD-ROM 108 or the like, and is temporarily stored in fixed disk 124. The software thus stored will be read from fixed disk 124 into memory 122 for execution by CPU 120.

The foregoing computer hardware itself is generally known. The computer includes a control circuit including a CPU, a storage circuit, an input circuit, an output circuit and an operating system, and thus has a structure for executing programs. The program according to the invention operates the above computer as a mask manufacturer selecting device. Accordingly, the most essential part of the invention is formed of the program stored in the flexible disk, CO-ROM, memory card, fixed disk and/or other record mediums.

Since operations of the computer itself shown in FIGS. 2 and 2 are well known, description thereof is not repeated.

Mask manufacturers' computers 200 shown in FIG. 1 are also formed of general computer systems. Thus, mask manufacturer's computer 200 has parts and portions corresponding to those of server 100 as indicated by parenthesized reference numbers in FIGS. 2 and 3.

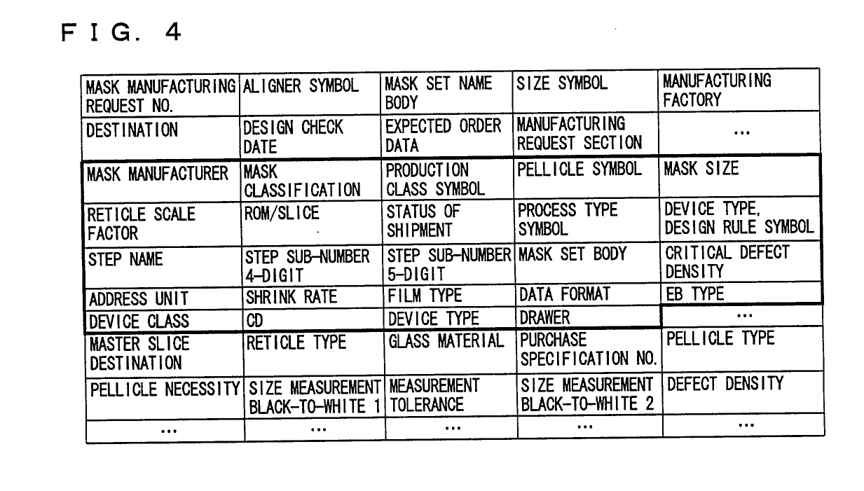

Referring to FIG. 4, description will now be given on order specification data stored in fixed disk 124 of server 100 according to the embodiment. The order specification data in FIG. 4 represents specifications, which are used when a wafer manufacturer places an order for a photomask with a mask manufacturer. As shown in FIG. 4, a plurality of items are stored. Among these items, factors significantly affecting the estimated price of the photomask are sent from server 100 to mask manufacturer's computer 200 as price factor data. For example, items surrounded by thick line in FIG. 4 are sent as the price factor data.

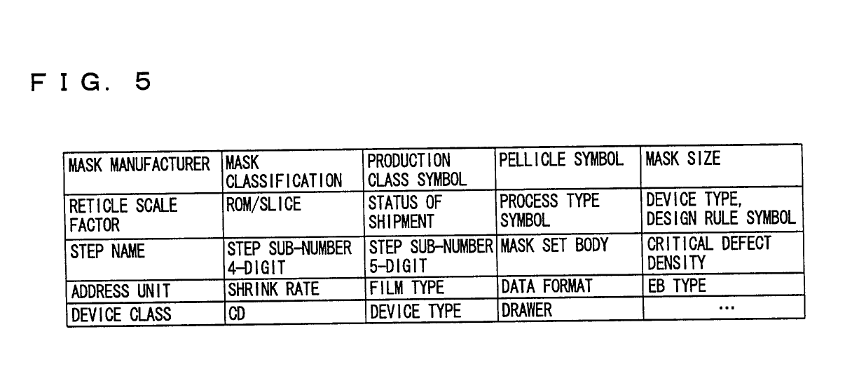

Referring to FIG. 5, description will now be given on the price factor data, which is sent from server 100 to mask manufacturer's computer 200 and significantly affects the estimated price of the photomask. This price factor data is prepared by extracting some of items as the factors, which significantly affect the estimated price, from the order specification data shown in FIG. 4. For example, items such as a mask manufacturer, mask classification, production class symbol, pellicle symbol and mask size are extracted. The price factor data shown in FIG. 5 is selected by the wafer manufacturer in its own manner from the order specification data shown in FIG. 4, and is sent to mask manufacturers' computers 200. Thus, the kinds of factors included in the price factor data shown in FIG. 5 depend on the wafer manufacturer.

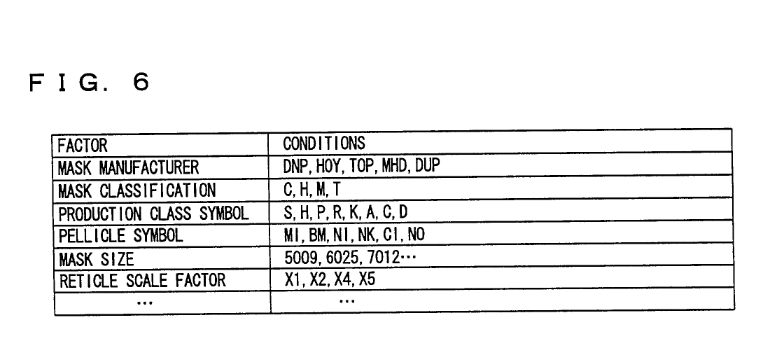

Referring to FIG. 6, description will now be given on the condition data, which is sent from server 100 to mask manufacturer's computer 200 and relates to the price factors. As shown in FIG. 6, conditions selectable by the mask manufacturer are determined for each of the factors included in the price factor data shown in FIG. 5. For example, conditions of the “mask manufacturer”, which is one of the factors significantly affecting the estimated price of the photomask, are determined, e.g., as “DNP”, “HOY”, “TOP”, “MHD” and “DUP” to allow selection by mask manufacturers.

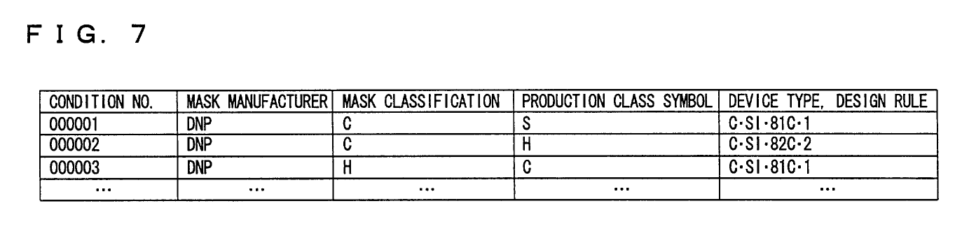

Referring to FIG. 7, description will now be given on price table data, which is sent from mask manufacturer's computer 200 to server 100. As shown in FIG. 6, the price table data includes condition data, which corresponds to the price factor data and is selected by the mask manufacturer, for each of condition numbers. For example, the mask manufacturer determines mask manufacturer “DNP”, mask classification “C”, production class symbol “S” and “device type, design rule” of “C-SI-81C-1” for the condition number “000001”. The contents determined as described above are sent to server 100. The data described above is sent from each of the plurality of manufacturers' computers 200 to server 100, and server 100 stores the plurality of price table data in fixed disk 124.

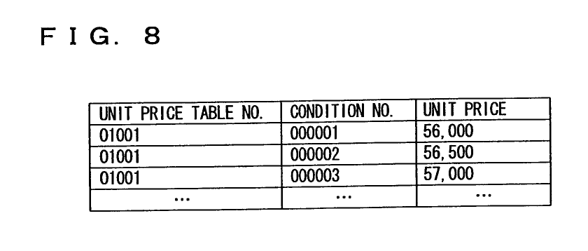

Referring to FIG. 8, description will now be given on the unit price data sent from mask manufacturer's computer 200 to server 100. As shown in FIG. 8, the unit price data includes a unit price (estimated price) of the photomask for each of the unit price table numbers and condition numbers. The condition number corresponds to the foregoing condition number shown in FIG. 7. Server 100 selects one from the plurality of mask manufacturers based on the condition number included in the received unit price data and the factors, which are contained in the received price table data and are selected by the mask manufacturers. In this operation, it is determined based on the condition number whether the factor selected by the mask manufacturer is contained in the order specification data and in the factors selected by the wafer manufacturer, or not. Thereafter, server 100 selects one mask manufacturer based on the unit price and others.

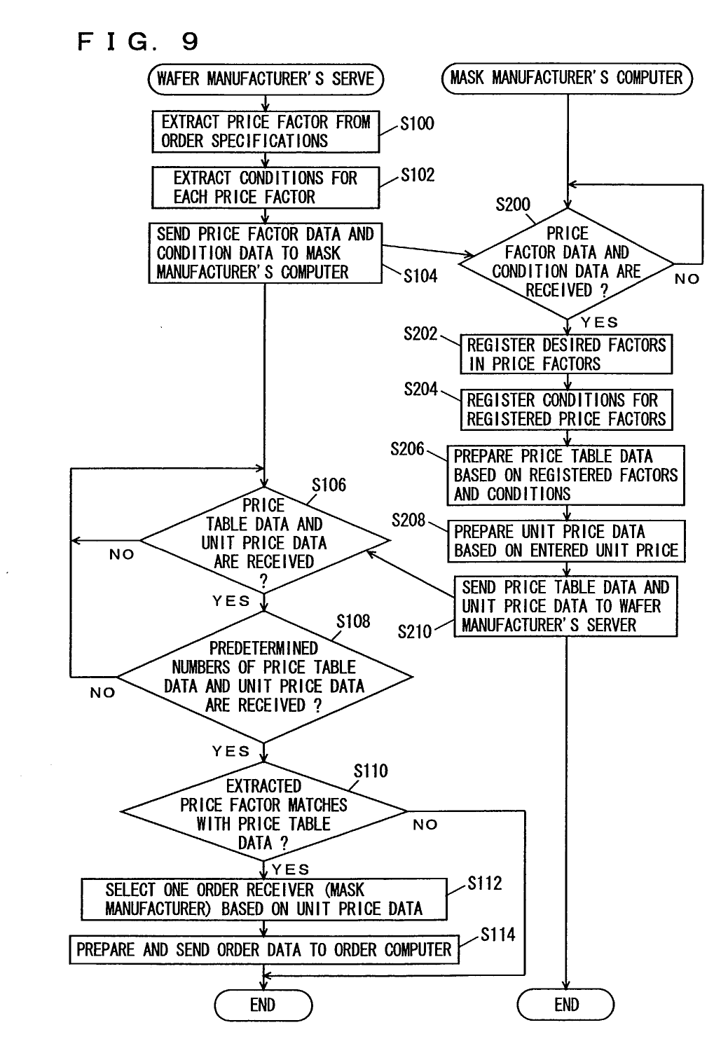

Referring to FIG. 9, description will now be given on a control structure of programs executed by server 100 and manufacturer's computer 200 in the mask manufacturer selecting system according to the embodiment.

In a step S100, CPU 120 of server 100 of the wafer manufacturer extracts the price factor data from the order specification data stored in fixed disk 124. In this operation, the price factor data shown in FIG. 5 is extracted from the order specification data shown in FIG. 4 based on the information entered by an operator or person in charge of this operation of the wafer manufacturer via keyboard 110, mouse 112 and/or the like of server 100.

In a step S102, CPU 120 extracts conditions for each price factor. In this operation, conditions for each price factor are extracted based on the information entered by the operator or person in charge of the wafer manufacturer via keyboard 110, mouse 112 and/or the like of server 100. The results thus selected are stored in fixed disk 124 as the condition data for each price factor as shown in FIG. 6.

In a step S104, CPU 120 sends price factor data (FIG. 5) and condition data (FIG. 6) to mask manufacturer's computer 200.

In a step S106, CPU 120 determines whether it has received the price table data (FIG. 7) and unit price data (FIG. 8) from mask manufacturer's computer 200 or not. When the price table data and unit price data are received from mask manufacturer's computer 200 (YES in step S106), the processing moves to a step S108. If not (NO in step S106), the processing returns to step S106 for waiting for the reception of the price table data and unit price data from mask manufacturer's computer 200.

In step S108, CPU 120 determines whether a predetermined number of price table data and unit price data are received or not. In this operation, different price table data and unit price data are received from the plurality of manufacturers' computers 200. When the predetermined number of price table data and unit price data are received (YES in step S108), the processing moves to a step S110. If not (NO in step S108), the processing returns to step S106 for waiting for the reception of the price table data and unit price data from mask manufacturer's computer 200.

In step S110, CPU 120 determines whether the price factor extracted in step S100 matches with the factor included in the price table data. If the extracted price factor matches with the price table data (YES in S110), the processing moves to a step S112. If not (NO in step S110), the processing ends in server 100 of the wafer manufacturer.

In step S112, CPU 120 selects one order receiver form the mask manufacturers based on the received unit price data. In a step S114, CPU 120 prepares and sends order data to order computer 300, i.e., computer for the ordering operation. Although it has been described that the processing in step S114 is performed for sending the order data to order computer 300, this is not restrictive. For example, CPU 120 of server 100 may prepare the order data, and may directly send it to mask manufacturer's computer 200.

In a step S200, a CPU 220 of mask manufacturer's computer 200 determines whether it has received the price factor data and condition data from server 100 or not. When it receives the price factor data and condition data (YES in step S200), processing moves to a step S202. If not (NO in step S200), processing returns to step S200 for waiting for the reception of the price factor data and condition data from server 100 of the wafer manufacturer.

In step S202, CPU 220 registers the desired factors selected from the received price factor data. In this operation, CPU 220 registers the factors selected by the mask manufacturer from the price factors extracted by the wafer manufacturer, based on information entered by an operator of the mask manufacturer via a keyboard 210, mouse 212 and/or the like of mask manufacturer's computer 200.

In a step S204, CPU 220 registers the conditions of the registered price factors. In this operation, CPU 220 displays a list of the received condition data on a monitor 204, and the operator of the mask manufacturer views the displayed contents, and enters the information. Based on this information, the conditions of the price factor are registered.

In a step S206, CPU 220 prepares the price table data (FIG. 7) based on the registered factor and conditions. In a step S208, CPU 220 prepares the unit price data (FIG. 8) based on the unit price, which is entered by the operator of the mask manufacturer via keyboard 210, mouse 212 and/or the like. In a step S210, CPU 220 sends the price table data (FIG. 7) and the unit price data (FIG. 8) to server 100 of the wafer manufacturer.

Based on the structure and flowchart described above, the mask manufacturer selecting system according to the embodiment operates as follows.

When the wafer manufacturer determines the photomask, of which price is to be estimated by the plurality of mask manufacturers, the operator of the wafer manufacturer extracts the price factor data from the order specification data corresponding to the photomask thus determined (step S100). The operator of the wafer manufacturer extracts the conditions for each of the extracted price factors (step S102). The price factor data (FIG. 5) extracted from the order specification data and the condition data (FIG. 6) corresponding to the extracted factor are sent to mask manufacturer's computer 200 (step S104).

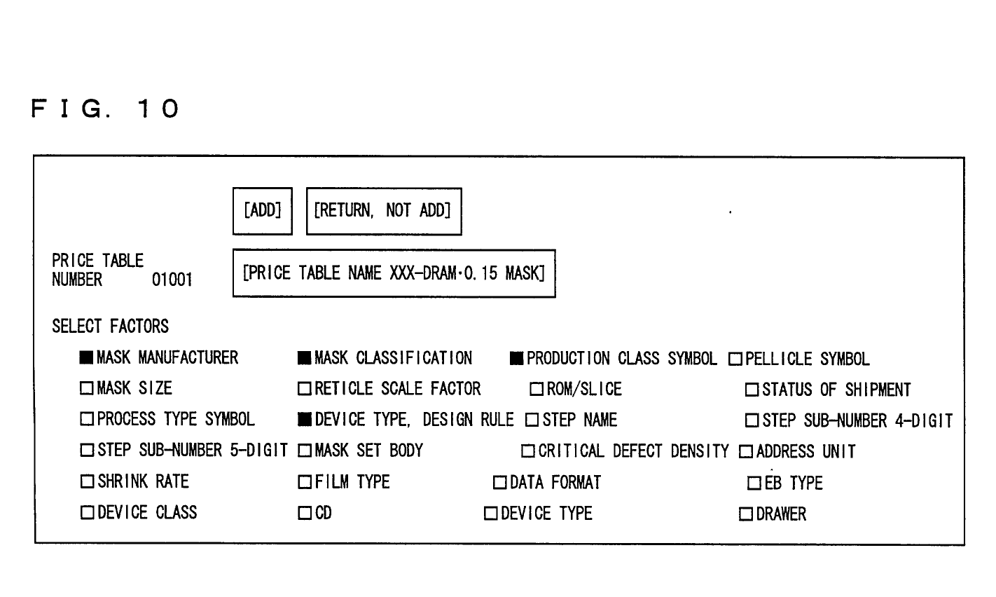

When mask manufacturer's computer 200 receives the price factor data and condition data (YES in step S200), the desired or intended data is extracted from the plurality of factors included in the received price factor data, based on the information entered by the operator of the mask manufacturer (step S202). In this operation, monitor 204 of mask manufacturer's computer 200 displays contents shown in FIG. 10. In FIG. 10, monitor 204 displays a list of selectable factors, and also displays the fact that the operator of the mask manufacturer selected the “mask manufacturer”, “mask classification”, “production class symbol” and “device type, design rule” via mouse 212.

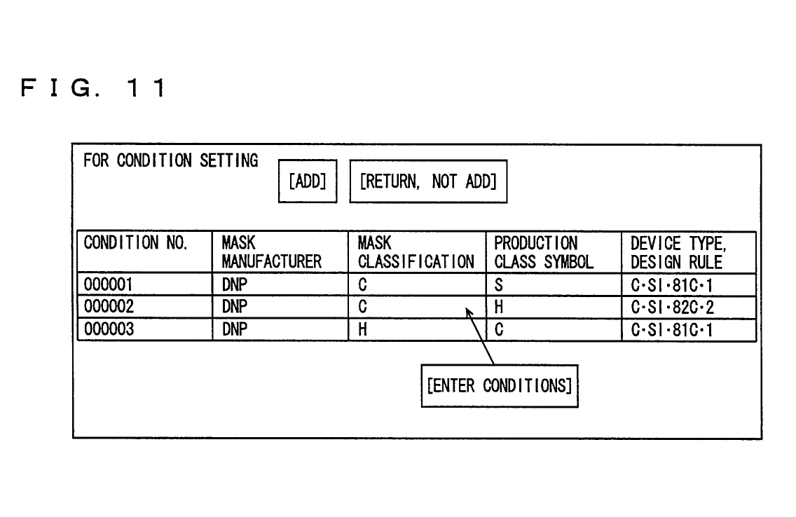

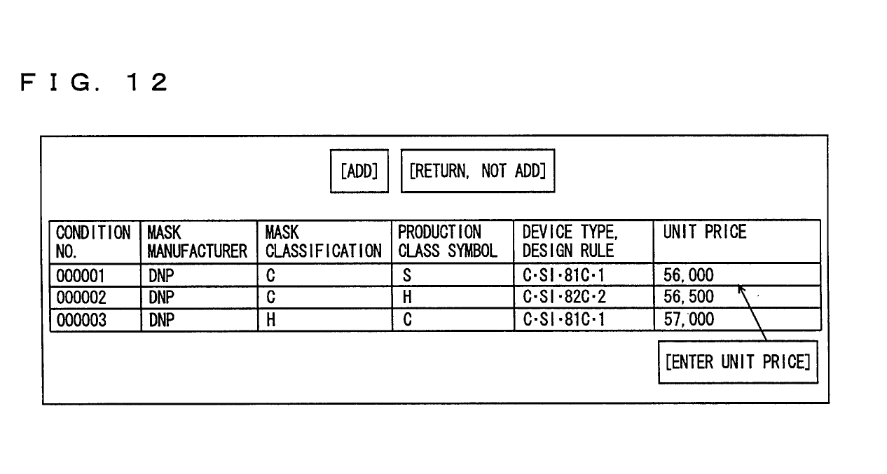

The operator of the mask manufacturer registers the conditions for the registered price factor (step S204). In this operation, monitor 204 of mask manufacturer's computer 200 displays the contents for setting the price table conditions as shown in FIG. 11. Based on the displayed contents shown in FIG. 11, the operator of the mask manufacturer sets the conditions selected from the condition data (FIG. 6), which is received from the wafer manufacturer, for each of the selected factors. Mask manufacturer's computer 200 prepares the price table data based on the registered factors and conditions (step S206). The operator of the mask manufacturer enters the unit prices via keyboard 210 or mouse 212 of mask manufacturer's computer 200, and mask manufacturer's computer 200 prepares the unit price data (FIG. 8) based on the unit prices thus entered (step S208). In this operation, monitor 204 of mask manufacturer's computer 200 displays the contents for entering the unit prices as shown in FIG. 12. The operator of the mask manufacturer enters the unit price of the photomask corresponding to the conditions entered for each condition number. Thereafter, the price table data and the unit price data thus prepared are sent to server 100 of the wafer manufacturer (step S210).

When server 100 of the wafer manufacturer receives the price table data and unit price data sent from mask manufacturer's computer 200 (YES in step S106), it is determined whether a predetermined number of data are received or not (step S108). More specifically, it is determined whether the price table data and the unit price data are received, e.g., from ten mask manufacturers or not. When the predetermined number of price table data and unit price data are received (YES in step S108), it is determined whether the extracted price factors match with the price table data or not (step S110). Thus, it is determined whether the price factors extracted by the wafer manufacturer match with the factors included in the price table data selected by the mask manufacturer or not. More specifically, it is determined whether all the factors selected by the mask manufacturer are included in the price factors extracted by the wafer manufacturer or not. When the extracted price factors match with the price table data (YES in step S110), one mask manufacturer is selected as the order receiver based on the received unit price data (step S112). The order data is prepared, and is sent to computer 200 of the selected mask manufacturer via order computer 300 so that the ordering processing is completed (step S114).

According to the mask manufacturer selecting system of the above embodiment, as described above, the wafer manufacturer, i.e., the orderer of the photomask selects in advance a plurality of factors. The selected factors significantly affect the estimated price of the photomask. The wafer manufacturer selects the conditions corresponding to the selected factors. The data representing the selected factors and conditions is sent to the computer of the mask manufacturer, i.e., manufacturer of the photomask. The mask manufacturer selects the factors, in which the manufacturer is strong, from the plurality of received factors, and sets the conditions corresponding to the selected factors. Based on the selected factors and set conditions, the operator of the mask manufacturer enters the unit price of the photomask.

The computer of the mask manufacturer sends the factors and unit price selected or entered by the operator of the mask manufacturer to the server of the wafer manufacturer. In the server of the wafer manufacturer, it is determined whether the factors selected by the mask manufacturer are present within the range selected in advance by the wafer manufacturer or not. If these are present in the range, one mask manufacturer is selected from the plurality of mask manufacturers based on the estimated price. Thereby, it is possible to obtain the estimated price, on which the features of the mask manufacturer are sufficiently reflected, without allowing free determination of the factors other than the specifications and quantity by the mask manufacturer. As a result, it is possible to achieve the order receiver selecting system, in which the manufacturer of photomasks or the like can be easily and accurately selected.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A selecting method of selecting one order receiver from two or more potential order receivers undertaking either manufacturing of an object or provision of service for an orderer, comprising the steps of:
entering, by said orderer, price factor data including two or more factors affecting a price to be paid by said orderer for said manufacturing of the object or said provision of the service; and
sending said price factor data to computers of said potential order receivers;
said potential order receivers receiving said price factor data preparing and sending estimate data including an estimated price for said manufacturing of the object or said provision of the service, based on the factors selected from said two or more factors; said method further including the steps of
receiving said estimate data;
storing said received estimate data; and
selecting one order receiver from said potential order receivers based on the two or more estimate data received from said two or more potential order receivers.

2. The selecting method according to claim 1, wherein
said object is a photomask used for manufacturing a semiconductor wafer, said orderer is a wafer manufacturer, and said order receiver is a mask manufacturer.

3. The selecting method according to claim 1, further comprising the step of:
preparing order data for said one order receiver selected in said step of selecting said one order receiver.

4. The selecting method according to claim 3, wherein
said object is a photomask used for manufacturing a semiconductor wafer, said orderer is a wafer manufacturer, and said order receiver is a mask manufacturer.

5. The selecting method according to claim 3, further comprising the step of:
sending said order data prepared in said step of preparing said order data to the computer of said order receiver.

6. The selecting method according to claim 5, wherein
said object is a photomask used for manufacturing a semiconductor wafer, said orderer is a wafer manufacturer, and said order receiver is a mask manufacturer.
